(19) United States
(12) Patent Application Publication
(10) Pub. No.: US 2015/0006933 A1
(43) Pub. Date: Jan. 1, 2015

(54) SYSTEM AND METHOD FOR LIMITING POWER OF BATTERY

(71) Applicants: KIA MOTORS CORPORATION, Seoul (KR); HYUNDAI MOTOR COMPANY, Seoul (KR)

(72) Inventors: Hyun Soo Park, Anyang (KR); Woo Sung Kim, Hwaseong (KR)

(73) Assignees: KIA MOTORS CORPORATION, Seoul (KR); HYUNDAI MOTOR COMPANY, Seoul (KR)

(21) Appl. No.: 14/045,119

(22) Filed: Oct. 3, 2013

(30) Foreign Application Priority Data
Jun. 28, 2013 (KR) 10-2013-0075165

(51) Int. Cl. G06F 1/32

(52) U.S. Cl. CPC G06F 1/3296
USPC 713/323

(57) ABSTRACT

A system and method for limiting power of a battery in which a minimum discharging voltage reference value and a slew rate for discharging power are prepared per temperature section and the slew rates for discharging power are applied differently according to temperatures. The method includes measuring, by a sensor, temperature of a battery and measuring, by a controller, a minimum voltage of a battery cell. The controller is configured to adjust a discharging limitation by reducing the discharging power limitation value by the slew rate for discharging power at a corresponding temperature section when the minimum voltage of a battery cell is less than the minimum discharging voltage reference value at the corresponding temperature section.

### CROSS-REFERENCE TO RELATED APPLICATION

This application claims under 35 U.S.C. §119(a) priority to Korean Patent Application No. 10-2013-0075165 filed on Jun. 28, 2013, the entire contents of which are incorporated herein by reference.

### BACKGROUND

(a) Technical Field

The present invention relates to a system and method for limiting power of a battery that improves durability of battery by maintaining a normal voltage region in a high voltage battery and improves vehicle power performance by applying a proper slew rate to a battery for limiting power thereof.

(b) Background Art

In general, in an environmentally friendly vehicle such as a hybrid vehicle that uses a high voltage battery, charging and discharging power (assist/regenerative of a motor) is determined within a power limitation value that is sent from a battery management system. An available power of a high voltage battery depends on a cell voltage of a battery wherein when the cell voltage is high, a charging power is limited, and when the cell voltage is low, a discharging power is limited. For this purpose, power of a battery in a battery management system (BMS) is limited by setting a limitation voltage value to limit the power and a recovery voltage value for recovering the power. Further, the limitation voltage value and the recovery voltage value are controlled with hysteresis to avoid a chattering.

When a voltage of a battery reaches a limitation voltage, a power limitation value of the BMS is reduced. Further, the power limitation value of the BMS is reduced continuously until the voltage of a battery reaches a recovery voltage, and after the voltage of a battery reaches the recovery voltage, the power limitation value of the BMS is increased. However, the power limitation value of the BMS is decreased abruptly according to instant increasing and decreasing of the voltage of a battery, thereby varying abruptly the charging and discharging amount of a hybrid vehicle to cause shock of a vehicle. In other words, the power limitation value of a battery management system is increased when the voltage of a battery reaches back to the recovery voltage while the power limitation value of a battery management system is reduced abruptly according to the instant voltage increasing and decreasing of a battery.

According to a related art, a slew rate for power limitation of BMS has been applied in a lump, regardless of characteristics and temperature of a battery, however, when the same slew rate as at a room temperature is applied at a low temperature, the risk of departing from a normal voltage region of a high voltage battery increases when the power limitation varies. Accordingly, the same slew rate as at a substantially low temperature may be applied at a room temperature and the power may be excessively limited when the power limitation varies, thereby decreasing power performance of a vehicle.

The description provided above as a related art of the present invention is merely for helping in the understanding of the background of the present invention and should not be construed as being included in the related art known by those skilled in the art.

### SUMMARY

The present invention provides a system and method for limiting power of a battery that may improve durability of battery by ensuring normal voltage region in a high voltage battery and improve vehicle power performance by applying a proper slew rate to a battery for limiting power thereof.

A method for limiting power of a battery in which a minimum discharging voltage reference value and a slew rate for discharging power may be prepared per temperature section and the slew rates for discharging power may be applied differently according to temperatures, may include: measuring temperature of a battery; measuring a minimum voltage of a battery cell; and adjusting the discharging limitation by reducing the discharging power limitation value by the slew rate for discharging power at the corresponding temperature section when the minimum voltage of a battery cell is less than the minimum discharging voltage reference value at the corresponding temperature section.

The method for limiting power of a battery may further include: cutting-off the discharging power limitation value to about 0 when the discharging power limitation value of a battery is decreased by the slew rate for discharging power at the corresponding temperature section, and as a result, the discharging power limitation value may be less than about 0.

A method for limiting power of a battery in which a maximum charging voltage reference value and a slew rate for charging power may be prepared per temperature section and the slew rates for charging power may be applied differently according to temperatures, may include: measuring temperature of a battery; measuring a maximum voltage of a battery cell; and adjusting the charging limitation by reducing the charging power limitation value by the slew rate for charging power at the corresponding temperature section when the maximum voltage of a battery cell is greater than the maximum charging voltage reference value at the corresponding temperature section.

The method for limiting power of a battery may further include: cutting-off the charging power limitation value to about 0 when the charging power limitation value of a battery is decreased by the slew rate for charging power at the corresponding temperature section, and as a result, the charging power limitation value is less than about 0.

A method for limiting power of a battery in which a maximum discharging voltage reference value and a slew rate for discharging power may be prepared per temperature section and the slew rates for discharging power may be applied differently according to temperatures, may include: measuring temperature of a battery; measuring a minimum voltage of a battery cell; and adjusting the discharging limitation by increasing the discharging power limitation value by the slew rate for discharging power at the corresponding temperature section when the minimum voltage of a battery cell is greater than the maximum discharging voltage reference value at the corresponding temperature section.

A method for limiting power of a battery in which a minimum charging voltage reference value and a slew rate for charging power may be prepared per temperature section and the slew rates for charging power may be applied differently according to temperatures, may include: measuring temperature of a battery; measuring a maximum voltage of a battery cell; and adjusting the charging limitation by increasing the charging power limitation value by the slew rate for charging power at the corresponding temperature section when the maximum voltage of a battery cell is less than the minimum charging voltage reference value at the corresponding temperature section.

In a method for limiting power of a battery, a slew rate for discharging power and a slew rate for charging power may be set per temperature section, and when a discharging power limitation value or a charging power limitation value of a battery should be decreased, the slew rate for discharging power or the slew rate for charging power at the corresponding temperature section may be applied to decrease the discharging power limitation value or the charging power limitation value in stages.

In a method for limiting power of a battery, a slew rate for discharging power and a slew rate for charging power may be set per temperature section, and when a discharging power limitation value or a charging power limitation value of a battery should be increased, the slew rate for discharging power or the slew rate for charging power at the corresponding temperature section may be applied to increase the discharging power limitation value or the charging power limitation value in stages.

### BRIEF DESCRIPTION OF THE DRAWINGS

The above and other features of the present invention will now be described in detail with reference to exemplary embodiments thereof illustrated the accompanying drawings which are given herein below by way of illustration only, and thus are not limitative of the present invention, and wherein:

FIG. 1 is an exemplary block diagram showing a method for limiting the power of a battery according to an exemplary embodiment of the present invention; and

FIG. 2 is an exemplary block diagram showing a method for limiting the power of a battery according to an exemplary embodiment of the present invention.

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles, fuel cell vehicles, and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below.

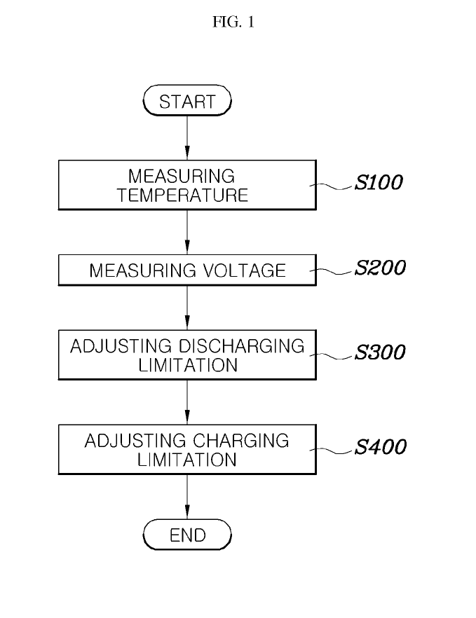

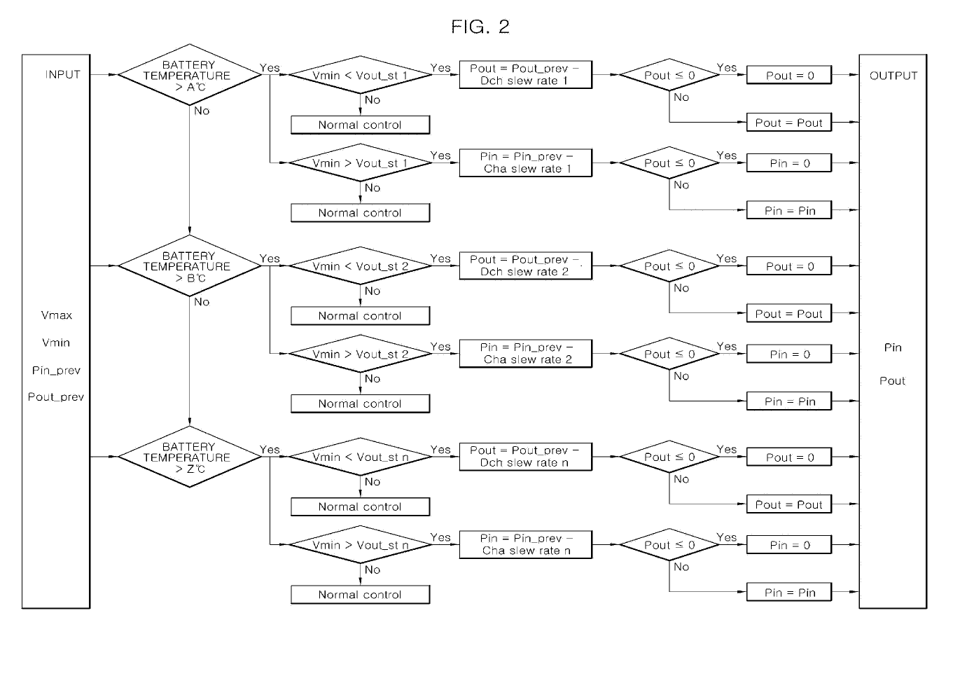

FIG. 1 is an exemplary block diagram showing a method, executed by a controller, for limiting the power of a battery according to an exemplary embodiment of the present invention; and FIG. 2 is an exemplary block diagram showing a method, executed by a controller, for limiting the power of a battery according to an exemplary embodiment of the present invention.

According to a method for limiting power of a battery of the present invention, a slew rate for discharging power and a slew rate for charging power may be set per temperature section, and when a discharging power limitation value or a charging power limitation value of a battery needs to be decreased, the slew rate for discharging power or the slew rate for charging power at the corresponding temperature section may be applied to decrease the discharging power limitation value or the charging power limitation value in stages. The various temperature sections refer to predetermined temperature sections sensitively affecting on performances of a battery.

According to another method for limiting power of a battery of the present invention, a slew rate for discharging power and a slew rate for charging power may be set per temperature section, and when a discharging power limitation value or a charging power limitation value of a battery needs to be increased, the slew rate for discharging power or the slew rate for charging power at the corresponding temperature section may be applied to increase the discharging power limitation value or the charging power limitation value in stages. In other words, for a high power battery of a vehicle, a charging power limitation value and a discharging power limitation value that limits respectively the charging power and discharging power may be applied when charging and discharging wherein the present invention relates to variations of the charging power limitation value and the discharging power limitation value according to various situations. The charging power limitation value and the discharging power limitation value may be varied in stages to seek voltage stabilization of battery cells wherein the power limitation values may be varied in stages with a constant slew rate.

Specifically, according to the present invention, the different slew rates may be applied based on temperature wherein according to a related art, when the power limitation value is varied uniformly with a constant slew rate, the voltage of a battery is unstable and is lowered to a minimum voltage or less, thereby causing malfunction with respect to determining stability of battery cells or affecting power performance of a vehicle. Accordingly, the property of a battery is linked with temperature wherein the slew rate is varied properly as experiment values according to temperature sections.

A battery is composed of a plurality of cells wherein a minimum cell voltage and a maximum cell voltage in a battery, that is, a minimum voltage and a maximum voltage of a battery cell may be measured by measuring voltage of each cell. Furthermore, the discharging of a battery may be determined and controlled based on the minimum voltage and the charging of a battery may be determined and controlled based on the maximum voltage, thereby operating the battery conservatively to maintain durability thereof.

Accordingly, the slew rate for discharging power and the slew rate for charging power may be set per temperature section. Further, when the discharging power limitation value or the charging power limitation value of a battery needs to be decreased, the slew rate for discharging power or the slew rate for charging power at a corresponding temperature section may be applied to decrease the discharging power limitation value or the charging power limitation value in stages.

Further, when the discharging power limitation value or the charging power limitation value of a battery needs to be increased, the slew rate for discharging power or the slew rate for charging power at a corresponding temperature section may be applied to increase the discharging power limitation value or the charging power limitation value in stages, and thus different slew rates may be applied based on the temperature sections, thereby operating the voltages of the battery cells more stably.

In particular, in a method for limiting power of a battery according to the present invention, a minimum discharging voltage reference value and a slew rate for discharging power may be prepared per temperature section and the slew rates for discharging power may be applied differently according to temperatures wherein the method may include steps of: measuring, by a sensor, temperature of a battery S100; measuring, by a controller, a minimum voltage of a battery cell S200; and adjusting, by the controller, the discharging limitation by reducing the discharging power limitation value by the slew rate for discharging power at the corresponding temperature section when the minimum voltage of a battery cell is less than the minimum discharging voltage reference value at the corresponding temperature section S300.

A minimum discharging voltage reference value and a slew rate for discharging power may be prepared per temperature section. When the minimum voltage of a battery cell is less than the minimum discharging voltage reference value at the corresponding temperature section, the discharging of a battery should be limited by decreasing the discharging power limitation value since when the battery is continuously discharged durability of the battery may be affected.

Accordingly, when the temperature of a battery is measured by a sensor, the minimum discharging voltage reference value at the corresponding temperature section and the minimum voltage of a battery cell may be compared by the controller. When the minimum voltage of a battery cell is less than the minimum discharging voltage reference value at the corresponding temperature section, the discharging power limitation value of the battery may be reduced by the slew rate for discharging power at the corresponding temperature section.

On the contrary, for charging, a maximum charging voltage reference value and a slew rate for charging power may be prepared per temperature section, and when the maximum voltage of a battery cell is greater than the maximum charging voltage reference value at the corresponding temperature section, the charging power limitation value may be decreased by the slew rate for charging power at the corresponding temperature section. In other words, the minimum discharging voltage reference value and the maximum charging voltage reference value for determining whether to limit the discharging or the charging may be set differently per temperature section and the slew rates according to the reference values may be set differently per temperature section, thereby ensuring optimum power limitation of a battery and durability of battery cells.

Moreover, when the discharging power limitation value or the charging power limitation value is decreased by applying the slew rates, the discharging power limitation value or the charging power limitation value may be calculated as about 0 to prevent error when the decreased value of the discharging power limitation value or the charging power limitation value is less than about 0.

Further, in another method for limiting power of a battery according to the present invention, a maximum discharging voltage reference value and a slew rate for discharging power may be prepared per temperature section and the slew rates for discharging power may be applied differently according to temperatures wherein the method may include steps of: measuring temperature of a battery S100; measuring a minimum voltage of a battery cell S200; and adjusting the discharging limitation by increasing the discharging power limitation value by the slew rate for discharging power at the corresponding temperature section when the minimum voltage of a battery cell is greater than the maximum discharging voltage reference value at the corresponding temperature section S300.

In other words, when the minimum voltage of a battery cell is greater than the maximum discharging voltage reference value at the corresponding temperature section, the discharging power limitation value may be increased reversely to respond when a further amount of discharging is required, and thus the discharging power limitation value of a battery may be increased by the slew rate for discharging power at the corresponding temperature section. According to the control logic as described above, the discharging power limitation value of a battery may be decreased and increased repeatedly in stages depending on the slew rate optimized for the corresponding temperature section.

Furthermore, even for the charging, in a method for limiting power of a battery according to the present invention, a minimum charging voltage reference value and a slew rate for charging power may be prepared per temperature section and the slew rates for charging power may be applied differently according to temperatures wherein the method may include steps of: measuring temperature, by a sensor, of a battery S100; measuring, by a controller, a maximum voltage of a battery cell S200; and adjusting, by the controller, the charging limitation by increasing the charging power limitation value of a battery by the slew rate for charging power at the corresponding temperature section when the maximum voltage of a battery cell is less than the minimum charging voltage reference value at the corresponding temperature section S400.

FIG. 2 is an exemplary block diagram showing a method for limiting the power of a battery according to an exemplary embodiment of the present invention. As shown in FIG. 2, reviewing the temperature section of a battery, when the temperature of a battery is greater than A, a logic of the corresponding temperature section is entered into. Furthermore, when a minimum voltage Vmin of a battery cell is measured and the measured minimum voltage Vmin is less than a minimum discharging voltage reference value Vout_st1 at the corresponding temperature section, the discharging power limitation value Pout of a battery may be decreased by the slew rate for discharging power at the corresponding temperature section. When the Vmin is greater than Vout_st1 at the corresponding temperature section, the discharging power limitation value Pout may be maintained (e.g., not varied) and the previous discharging power limitation value Pout_prev may be maintained.

Similarly, when a maximum voltage Vmax of a battery cell is measured and the measured maximum voltage Vmax is greater than a maximum charging voltage reference value Vin_st1 at the corresponding temperature section, a charging power limitation value Pin of a battery may be decreased by the slew rate for charging power at the corresponding temperature section. When the Vmax is less than the Vin_st1 at the corresponding temperature section, the charging power limitation value Pin of a battery may be maintained (e.g., not varied) and the previous charging power limitation value Pin_prev may be maintained.

The above logics may be applied to when the minimum voltage of a battery cell is compared with the maximum discharging voltage reference value to increase the discharging power limitation value, or the maximum voltage of a battery cell is compared with the minimum charging voltage reference value to increase the charging power limitation value.

According to the method for limiting power of a battery as configured-above, optimum parameters may be applied according to the characteristics and environmental conditions of a battery to satisfy durability of the battery, and further available power of the battery may be actively controlled according to external conditions, thereby enabling to utilize available maximum power of the battery. According to the method for limiting power of a battery, a lowering phenomenon of a cell voltage that is exhibited at a specific temperature section may be prevented in advance

The invention has been described in detail with reference to exemplary embodiments thereof. However, it will be appreciated by those skilled in the art that changes may be made in these exemplary embodiments without departing from the principles and spirit of the invention, the scope of which is defined in the accompanying claims and their equivalents.

What is claimed is:

1. A method for limiting power of a battery in which a minimum discharging voltage reference value and a slew rate for discharging power are prepared per temperature section and the slew rates for discharging power are applied differently according to temperatures, comprising:
measuring, by a sensor, a temperature of a battery;
measuring, by a controller, a minimum voltage of a battery cell; and
adjusting, by the controller, a discharging limitation by reducing the discharging power limitation value by the slew rate for discharging power at a corresponding temperature section when the minimum voltage of a battery cell is less than the minimum discharging voltage reference value at the corresponding temperature section.

2. The method for limiting power of a battery of claim 1, further comprising:
cutting-off, by the controller, the discharging power limitation value to about 0 when the discharging power limitation value of a battery is decreased by the slew rate for discharging power at the corresponding temperature section, causing the discharging power limitation value to be less than about 0.

3. A method for limiting power of a battery in which a maximum charging voltage reference value and a slew rate for charging power are prepared per temperature section and the slew rates for charging power are applied differently according to temperatures, comprising:
measuring, by a sensor, a temperature of a battery;
measuring, by a controller, a maximum voltage of a battery cell; and
adjusting, by the controller, a charging limitation by reducing the charging power limitation value by the slew rate for charging power at a corresponding temperature section when the maximum voltage of a battery cell is greater than the maximum charging voltage reference value at the corresponding temperature section.

4. The method for limiting power of a battery of claim 3, further comprising:
cutting-off, by the controller, the charging power limitation value to about 0 when the charging power limitation value of a battery is decreased by the slew rate for charging power at the corresponding temperature section, causing the charging power limitation value to be less than about 0.

5. A method for limiting power of a battery in which a maximum discharging voltage reference value and a slew rate for discharging power are prepared per temperature section and the slew rates for discharging power are applied differently according to temperatures, comprising:
measuring, by a sensor, a temperature of a battery;
measuring, by a controller, a minimum voltage of a battery cell; and
adjusting, by the controller, a discharging limitation by increasing the discharging power limitation value by the slew rate for discharging power at a corresponding temperature section when the minimum voltage of a battery cell is greater than the maximum discharging voltage reference value at the corresponding temperature section.

6. A method for limiting power of a battery in which a minimum charging voltage reference value and a slew rate for charging power are prepared per temperature section and the slew rates for charging power are applied differently according to temperatures, comprising:
measuring, by a sensor, a temperature of a battery;
measuring, by a controller, a maximum voltage of a battery cell; and
adjusting, by the controller, a charging limitation by increasing the charging power limitation value by the slew rate for charging power at a corresponding temperature section when the maximum voltage of a battery cell is less than the minimum charging voltage reference value at the corresponding temperature section.

7. A method for limiting power of a battery, wherein a slew rate for discharging power and a slew rate for charging power are set per temperature section, and when a discharging power limitation value or a charging power limitation value of a battery is to be decreased, the slew rate for discharging power or the slew rate for charging power at the corresponding temperature section is applied to decrease the discharging power limitation value or the charging power limitation value in stages.

8. A method for limiting power of a battery, wherein a slew rate for discharging power and a slew rate for charging power are set per temperature section, and when a discharging power limitation value or a charging power limitation value of a battery needs to be increased, the slew rate for discharging power or the slew rate for charging power at the corresponding temperature section is applied to increase the discharging power limitation value or the charging power limitation value in stages.

9. A system for liming power of a battery, in which a minimum discharging voltage reference value and a slew rate for discharging power are prepared per temperature section and the slew rates for discharging power are applied differently according to temperatures, comprising:
a controller includes a memory and a processor, the memory configured to store program instructions and the processor configured to execute the program instructions, the program instructions when executed configured to:
control a sensor to measure a temperature of a battery;
measure a minimum voltage of a battery cell; and
adjust a discharging limitation by reducing the discharging power limitation value by the slew rate for discharging power at a corresponding temperature section when the minimum voltage of a battery cell is less than the minimum discharging voltage reference value at the corresponding temperature section.

10. The system of claim 9, wherein the program instructions when executed are further configured to:
cut-off the discharging power limitation value to about 0 when the discharging power limitation value of a battery is decreased by the slew rate for discharging power at the corresponding temperature section, causing the discharging power limitation value to be less than about 0.

11. A non-transitory computer readable medium containing program instructions executed by a controller, the computer readable medium comprising:
program instructions that control a sensor to measure a temperature of a battery;
program instructions that measure a minimum voltage of a battery cell; and
program instructions that adjust a discharging limitation by reducing the discharging power limitation value by the slew rate for discharging power at a corresponding temperature section when the minimum voltage of a battery cell is less than the minimum discharging voltage reference value at the corresponding temperature section.

12. The non-transitory computer readable medium of claim 11, further comprising:
program instructions that cut-off the discharging power limitation value to about 0 when the discharging power limitation value of a battery is decreased by the slew rate for discharging power at the corresponding temperature section, causing the discharging power limitation value to be less than about 0.
